(19) United States
(12) Patent Application Publication
(10) Pub. No.: US 2021/0252677 A1
(43) Pub. Date: Aug. 19, 2021

(54) TOOL FOR TIGHTENING NUT ON A BOLT TO FORM A FIXED CONNECTION

(71) Applicant: Patentec Quickdrive AS, Arendal (NO)

(72) Inventor: Hilberg Inge Karoliussen, His (NO)

(21) Appl. No.: 17/252,562

(22) PCT Filed: Jun. 20, 2019
(86) PCT No.: PCT/NO2019/050131

§ 371 Date: Dec. 15, 2020

(30) Foreign Application Priority Data
Jun. 20, 2018 (NO) 20180870

(51) Int. Cl. B25B 21/00; B25B 29/02

(52) U.S. Cl. CPC B25B 21/005; B23P 19/067; B25B 29/02

(57) ABSTRACT

A Tool for tightening a nut on a bolt to form a fixed connection, consisting of an air-driven hydraulic pump which transfers oil pressure to a hydraulic cylinder with a piston connected to a shaft which by means of an air-driven motor (90′) is caused to screw on the threads of the bolt where the nut is connected to a second separate air-driven motor (91′) that screws the nut on the said bolt as the bolt is stretched.

### FIELD OF INVENTION

The invention relates to a tool for tightening nuts on bolts, where bolt and nut are used as fixing means.

### BACKGROUND

Tools most known for such use are Fixed Wrenches and Spanner Wrenches that are used where there are no given requirements on the tightening torque and accuracy of the tightening. But for example, something as common as wheel nuts on vehicles requires more accuracy, so here the last step of the tightening is done is by means of torque wrenches.

In machines and pipe connections in the offshore and process industries, the requirements for accurate tightening of bolts are often very strict and are performed according to procedures involving both lubricant and how to apply of this onto the threads and the narrow limits for the torque. Nevertheless, it turns out that different tension occurs in the bolts due to the variation in friction between threads and between nut and base material or washer which is typical used.

Some of these known bolt tension tools for tightening the bolts and nuts together in a fixed connection consist of hollow hydraulic cylinders with a mounting surface in the bottom, with a recessed and rotationally free device to retract the nut, as well as an external high-pressure oil pump. When the oil is pressed into the cylinder, the bolt is stretched with a force determined by the pressure and the nut is then screwed on. Then the oil pressure is relieved, and the set is unscrewed for use on the next bolt. With this method one gets even and accurate tension in all the bolts.

The application EP3126096 is describing a technology where the tool also having a tension rod which tensioning the bolt. The tension rod here has no simple releasable link for replacing the pipe head. Nor has any integrated mechanism been provided for tightening the nut, which must be tightened and loosened manually with a separate torque rod.

### SUMMARY OF THE INVENTION

It is an object of the present invention to provide a tool which has all the necessary sequential functions and elements built into it and only need to replace a nozzle assembly to adapt the tool to different bolt and nut sizes, making the tool time efficient and easy to use in line with other hand tools. Said nozzle assembly includes a tensioning shaft and pipe adapted to the particular size of the bolt and nut concerned. To operate in hazardous areas, the tool will preferably only operate with compressed air as a power supply in air-room facilities to avoids the dangers and disadvantages of external high-pressure hydraulic fittings such as hoses and connections.

The inventive tool will be suitable for mounting on remote controlled devices such as robots and underwater vehicles, usually referred to as ROV's. Here the power supply will be hydraulics in the form of water or some type of oil or in the combination. In this embodiment the handle will be replaced with a connector and trigger system suitable.

A preferred embodiment of the tool for tightening the nut on the bolt to form the fixed connection, includes a first motor, a bolt tensioner shaft with internal threads which connects to the bolt, wherein the bolt tensioner shaft is adapted to be rotated by the first motor, a locking claw connecting the bolt tensioner shaft to an upper hydraulic tensioner shaft a hydraulic piston attached to said hydraulic tensioner shaft, an oil pump supplying oil to the hydraulic piston wherein the hydraulic piston is adapted to extend and stretch the bolt when an oil pressure is introduced from the oil pump to the hydraulic piston. A second motor and a pipe which is swivel-connected axially to the bolt tensioner shaft for engaging the nut, wherein the pipe is adapted to be rotated by the second motor.

A more preferred embodiment also including a gear mechanism with first and second gear wheel rotatable mounted on a common gear shaft, wherein the first gear wheel is adapted to transfer rotational motion from the first fluid driven motor to the bolt tensioner shaft and the second gear wheel is adapted to transfer rotational motion from the second fluid driven motor to the pipe.

An even more preferred embodiment including a display system with a microprocessor connected to the said display system, and an oil pressure sensor connected to the microprocessor, wherein the pressure sensor is detecting the oil pressure delivered from the oil pump which is shown on the display.

Most preferred embodiment is further including a fluid pressure sensor detecting the fluid pressure delivered to the first and second fluid driven motors, wherein the first and second motors are powered by a fluid or electricity.

These objects are solved by a tool as disclosed in the appended claims.

### BRIEF DESCRIPTION OF THE DRAWINGS

The invention will now be described in more detail and with reference to the appended in which:

FIG. 1A showing a left side view of the tool.

FIG. 1B showing the tool underneath.

FIG. 1C showing a perspective of the of the tool.

FIG. 2A showing a section view of the cylinder house including the replaceable nozzle.

FIG. 2B showing a sub assembly of the mechanism, including the replaceable nozzle.

FIG. 3A showing a detail section of the pneumatic house.

FIG. 3B showing the detailed view of the motor house.

FIG. 4 showing the schematics of the total system.

### DETAILED DESCRIPTION OF THE DRAWINGS

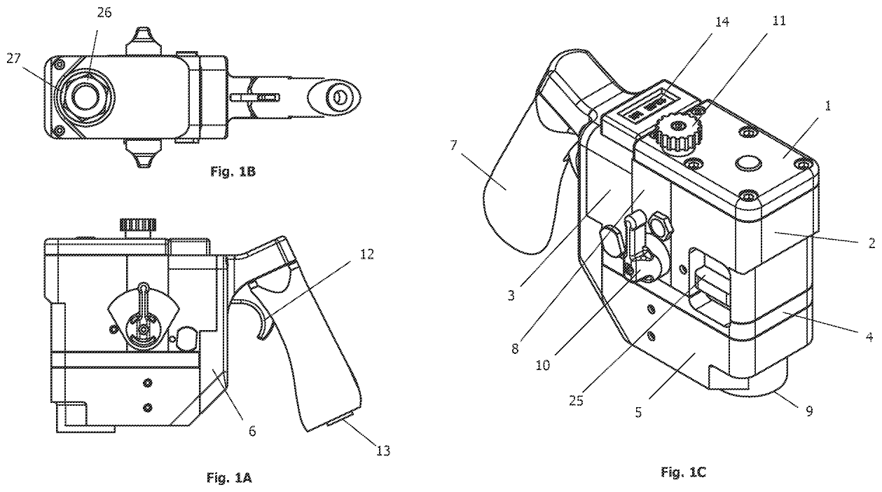

FIG. 1A-B-C, showing the position of; a cap 1 mounted with bolts on top of the cylinder house for hydraulics 2. cylinder house for air-supply 3 mounted at the rear part of the tool, the middle plate 4 mounted between the said cylinder houses 2, 3 and the air motor house 5 which is the lowest part of the tool and housing the motors.

The rear plate 6 bolted to the said cylinder house for hydraulics 2 thru the said cylinder house for pneumatics 3 and connects the handle 7 to the tool. Valve house 8 is placed between the said cylinder houses 2, 3, including the operational switch 10 which change the direction of rotation placed with handles on both side of the tool and the Regulator for Maximum Pressure 11 for regulating the power supply pressure where the wheel for regulating the pressure is placed on top right of the top plate 1. A stub 9 in the very bottom of the construction for direct interface towards the base material or a washer or the like.

A trigger 12 which open and close the valve regulating the power supply flow, as part of the handle 7, and a power supply coupler 13 which is the connection between the tool and the power supply, and finally a display including a microprocessor adapted to read and analyse sensor data coming from pressure sensors in the power supply system and/or sensors in the hydraulic power system.

Further in the cylinder house for hydraulics 2 a locking claw 25 is provided for enabling the replacement of the nozzle including the bolt tensioner shaft 26 which connects to the bolt and the pipe 27 which rotates the nut.

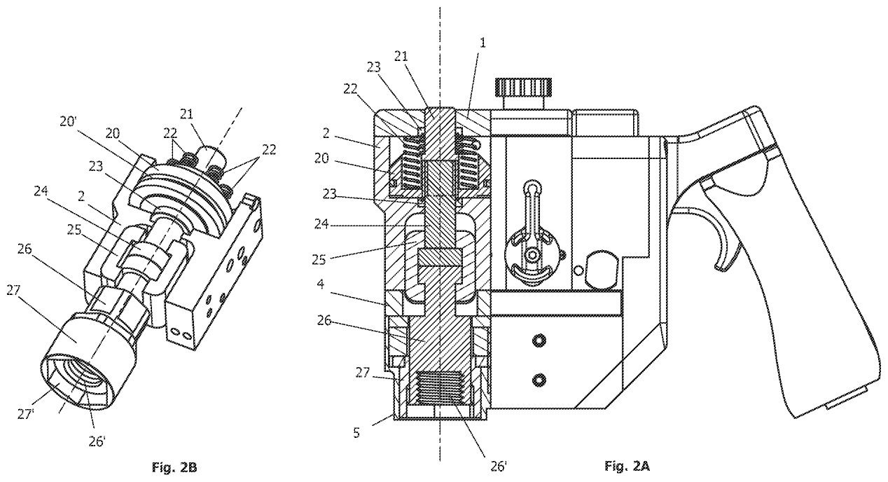

FIG. 2A-B, showing a detailed view of the said hydraulic cylinder house 2 and every part visualized with numbering.

A hydraulic piston 20 including an O-ring seal 20′, capable of moving in vertical directions, housing Springs 22 providing positive down force. A hydraulic shaft 21 is connected to the said Hydraulic Piston and is sealed both on the upper side and on the bottom side of the hydraulics with Seals 23. An upper hydraulic tensioner shaft 24 underneath and screwed into the said Hydraulic Piston connects the upper hydraulic system to a locking claw 25.

This said locking claw connects the said upper hydraulic tensioner shaft 24 with a replaceable bolt tensioner shaft 26. Said bolt tensioner shaft has an inner thread 26′ which enables the Shaft 26 to be screwed onto a bolt and transfers the force from the tool to the said bolt. A standard sized pipe 27 with standard hexagonal interface 27′ for the nut is swivel connected to the said shaft 26.

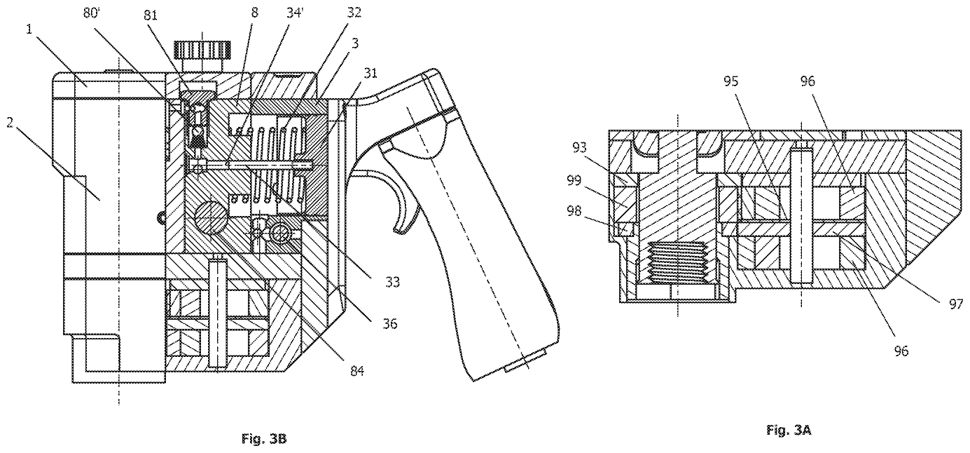

FIG. 3A-B, showing a detailed view of the pneumatic cylinder house 3, the motor house 5 and every part visualized with numbering.

An air-driven piston 31 activating a Piston 33 which activates an Oil Pump 34′ capable of increasing or decreasing the hydraulic pressure acting on the said hydraulic piston. A Return Spring 32 pushing the said air-driven piston back to the showed start position when no air pressure is acting on the said piston.

A Communicator Pin 36 for controlling the air flow acting on the said air-driven piston. An Inlet Valve 80′ of check valve type, securing the flow. And with a Valve Plug 81 mounted to the top of the air supply cylinder house 3. And a flow turn pin 84 for directing the air flow.

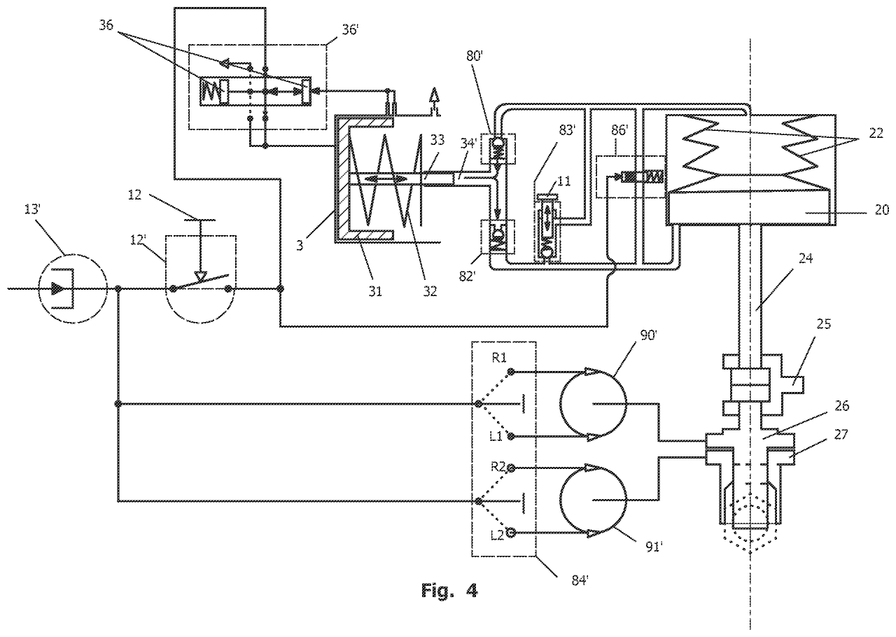

FIG. 4, showing a function and connection diagram for the tool where the operator first adjust the force wanted to stretch the bolts using the wheel 11 on the maximum pressure regulator (83′), and placing the tool on the bolt and activate the operational switch in a first position which activates the Air Motor 90′ to screw the tension rod 24 onto the bolt threads at the same time as a fitted pipe 27 enters the nut and turn it to enter the same bolt threads.

Then by actuating a Valve 12′ via the trigger 12, the internal air-driven hydraulic pump 34′ and start pressing oil into the hydraulic cylinder where a piston 20 pulls the tension bar 24 and extends the bolt while the nut is simultaneously actuated by torque from the air motor 91′. When the predetermined tension for the bolt is reached, the operational switch is moved to a second position whereby the air motor 90′ goes in reverse.

The trigger 12 is released, whereby the oil pump 34′ stops and the oil pressure is released by the pressure relief valve 86′ opening when the air pressure from the valve 12′ is absent and the tool is unscrewed by the bolt and ready for the next bolt and nut.

1-5. (canceled)

6. A tool to tighten a nut on a bolt to form a fixed connection by first stretching the bolt with a set force with subsequent screwing on the nut for correct prestress, the tool comprising:
a first motor;
a bolt tensioner shaft including internal threads which connects to the bolt, wherein the bolt tensioner shaft is adapted to be rotated by the first motor;
a hydraulic piston;
an oil pump adapted to supply oil to the hydraulic piston, wherein the hydraulic piston is adapted to extend when an oil pressure is introduced from the oil pump to the hydraulic piston and the extension of the hydraulic piston stretches the bolt, and wherein the hydraulic piston is attached to a hydraulic tensioner shaft that is connected to the bolt tensioner shaft by a locking claw;
a second motor; and
a pipe that is adapted to be rotated by the second motor, wherein the pipe is swivel-connected axially to the bolt tensioner shaft for engaging the nut.

7. A tool according to claim 6, further including a gear mechanism with first and second gear wheel rotatable mounted on a static common gear shaft, wherein the first gear wheel is adapted to transfer rotational motion from the first motor to the bolt tensioner shaft, and the second gear wheel is adapted to transfer rotational motion from the second motor to the pipe.

8. A tool according to claim 7, further including a fluid pressure sensor detecting the fluid pressure delivered to the first and second motors.

9. A tool according to claim 7, further including a display, a microprocessor connected to the display, an oil pressure sensor connected to the microprocessor, wherein the pressure sensor is configured to detect the oil pressure delivered from the oil pump, and wherein the oil pressure is shown on the display.

10. A tool according to claim 9, further including a fluid pressure sensor detecting the fluid pressure delivered to the first and second motors.

11. A tool according to claim 6, wherein the first and second motors are powered by a fluid or electricity.

12. A tool according to claim 6, further including a display, a microprocessor connected to the display, an oil pressure sensor connected to the microprocessor, wherein the pressure sensor is configured to detect the oil pressure delivered from the oil pump, and wherein the oil pressure is shown on the display.

13. A tool according to claim 6, further including a fluid pressure sensor detecting the fluid pressure delivered to the first and second motors.
